(19) United States
(12) Patent Application Publication
(10) Pub. No.: US 2026/0045794 A1
(43) Pub. Date: Feb. 12, 2026

(54) DISPLAY DEVICE AND OPERATING METHOD THEREOF

(71) Applicant: LG ELECTRONICS INC., Seoul (KR)

(72) Inventor: Doosung An, Seoul (KR)

(73) Assignee: LG ELECTRONICS INC., Seoul (KR)

(21) Appl. No.: 19/065,857

(22) Filed: Feb. 27, 2025

(30) Foreign Application Priority Data
Aug. 8, 2024 (WO) PCT/KR2024/011776

(51) Int. Cl. H02J 3/00; G02F 1/133

(52) U.S. Cl. CPC H02J 3/0012; G02F 1/133

(57) ABSTRACT

An electronic device according to an embodiment of the present disclosure may comprise a first detection circuit configured to output a signal indicating whether a first adapter is connected; and a main board configured to: detect a disconnection of the first adapter based on the signal output from the first detection circuit while the first adapter and a second adapter are connected simultaneously, and switch a power source of the electronic device from the first adapter to the second adapter according to detecting the disconnection of the first adapter.

### CROSS-REFERENCE TO RELATED APPLICATION

Pursuant to 35 U.S. C. § 119(a), this application claims the benefit of earlier filing date and right of priority to PCT patent Application No. PCT/KR2024/011776, filed on Aug. 8, 2024, the contents of which are all hereby incorporated by reference herein in its entirety.

### BACKGROUND OF THE INVENTION

### 1. Field of the Invention

The present disclosure relates to a display device, and more specifically, to a stand-type display device.

### 2. Discussion of the Related Art

Stand-type display devices are products with unique designs and convenient functions, providing users with a new type of viewing experience.

The stand-type display device is equipped with wheels on the stand, so it may be easily moved and used anywhere in the house. This allows the display device to be conveniently used in various spaces such as the kitchen, living room, and bedroom.

Additionally, the stand-type display device may rotate the screen 90 degrees, allowing it to be used in both portrait and landscape modes. This makes it useful for viewing photos, working with documents, and using social media.

In addition, a stand-type display device may adjust the height and angle of the screen, allowing convenient viewing according to the user's gaze.

A stand-type display device may receive power in various forms. For example, a stand-type display device may be powered by a DC (DC) adapter, Universal Serial Bus Power Delivery (USB PD) adapter, or battery.

Whether or not the DC adapter is connected is detected through the power board, and the detected signal is transmitted to the main board.

Whether the USB PD adapter is connected is detected using the PD communication chip provided on the main board.

The battery's capacity and charging status are checked through the charging board provided on the main board.

If the DC adapter and USB PD (Power Delivery) adapter are simultaneously connected to a stand-type display device and the DC adapter is disconnected, the power is switched to the USB PD (Power Delivery) adapter to ensure smooth power supply. Do it.

However, the natural discharge time of the capacitor inside the DC adapter or the capacitor on the path from the DC adapter to the main board is delayed, resulting in a delay in switching to the USB PD adapter.

Additionally, when either the DC adapter or the USB PD adapter is connected to a stand-type display device, battery discharge occurs due to a pre-boost operation. As a result, a problem occurs in which the battery recharges frequently.

### SUMMARY OF THE INVENTION

The purpose of the present disclosure may be to quickly detect whether the DC adapter is disconnected (or blocked) by monitoring the output voltage of the DC adapter.

A purpose of the present disclosure may be to quickly detect disconnection of a DC adapter and switch the power source to another adapter.

The purpose of the present disclosure may be to block battery discharge by turning off the power of the pre-boost IC (or boost circuit) when either the DC adapter or the USB PD adapter is connected to the display device.

An electronic device according to an embodiment of the present disclosure may comprise a first detection circuit configured to output a signal indicating whether a first adapter is connected; and a main board configured to: detect a disconnection of the first adapter based on the signal output from the first detection circuit while the first adapter and a second adapter are connected simultaneously, and switch a power source of the electronic device from the first adapter to the second adapter according to detecting the disconnection of the first adapter.

A method of operating an electronic device according to an embodiment of the present disclosure may comprise outputting a signal indicating whether a first adapter is connected; detecting a disconnection of the first adapter based on the signal output from a first detection circuit while the first adapter and a second adapter are connected simultaneously, and switching a power source of the electronic device from the first adapter to the second adapter according to detecting the disconnection of the first adapter.

According to an embodiment of the present disclosure, the output voltage of the DC adapter may be monitored, and whether to remove power from the DC adapter may be quickly determined through an output signal according to the monitoring result. Accordingly, the delay in the detection time required to detect whether the DC adapter is connected to power may be improved by discharging the capacitor present inside the DC adapter or the capacitor in the path connected from the DC adapter to the charging board.

According to an embodiment of the present disclosure, when the DC adapter and the USB PD adapter are simultaneously connected and the DC adapter is disconnected, the power source is quickly switched to the USB PD adapter, thereby smoothly supplying power to the elements of the display device. It may be.

According to an embodiment of the present disclosure, when either the DC adapter or the USB PD adapter is connected to the display device, power applied to the boost circuit may be blocked through the boost blocking circuit.

Accordingly, the power required for the boost operation is no longer needed, so the battery may not be discharged. As the battery is not discharged, the recharge cycle of the battery is reduced, thereby solving the problem of battery heat generation and reduced lifespan.

### BRIEF DESCRIPTION OF THE DRAWINGS

FIGS. 1A and 1B are diagrams illustrating the structure of a display device according to an embodiment of the present disclosure.

FIG. 2 is a block diagram showing the configuration of a display device according to an embodiment of the present disclosure.

FIG. 3 is a diagram illustrating the configuration of a display device according to an embodiment of the present disclosure.

FIG. 4 is a diagram illustrating the configuration of a charging board according to an embodiment of the present disclosure.

FIG. 5 is a diagram illustrating a circuit diagram of a detection circuit according to an embodiment of the present disclosure.

FIG. 6 is a diagram illustrating the operating principle of an LDO circuit according to an embodiment of the present disclosure.

FIG. 7 is a flowchart illustrating a method of operating a display device according to an embodiment of the present disclosure.

FIG. 8 is a block diagram showing the configuration of a head according to another embodiment of the present disclosure.

FIG. 9 is a flowchart for illustrating a method of operating a display device according to another embodiment of the present disclosure.

FIG. 10 is a diagram illustrating the configuration of a head according to another embodiment of the present disclosure.

FIG. 11 is a diagram illustrating a circuit diagram of a second detection circuit and a boost blocking circuit according to an embodiment of the present disclosure.

FIG. 12 is a flowchart for illustrating a method of operating a display device according to another embodiment of the present disclosure.

FIG. 13 is a flowchart for illustrating a method of operating a display device according to another embodiment of the present disclosure.

FIG. 14 is a diagram illustrating an effect that occurs when disconnection of a DC adapter is detected using a detection circuit according to an embodiment of the present disclosure.

### DETAILED DESCRIPTION OF THE PREFERRED EMBODIMENTS

Hereinafter, embodiments related to the present invention will be described in more detail with reference to the drawing. The suffixes “module” and “part” for component used in the following description are given or used interchangeably only for the ease of preparing the specification, and do not have distinct meanings or roles in themselves.

The directional indications Up (U), Down (D), Left (Le), Right (Ri), Front (F), and Rear (R) shown in the drawings are provided for the convenience of explanation only and do not limit the technical ideas disclosed in this specification.

The display device according to an embodiment of the present invention is, for example, an intelligent display device that adds a computer support function to the broadcast reception function, and is faithful to the broadcast reception function while adding an Internet function, etc., such as a handwriting input device and a touch screen. Alternatively, it may be equipped with a more convenient interface such as a spatial remote control. In addition, by supporting wired or wireless Internet functions, it is possible to connect to the Internet and a computer and perform functions such as email, web browsing, banking, or gaming. A standardized general-purpose OS may be used for these various functions.

Accordingly, in the display device described in the present invention, for example, various applications may be freely added or deleted on a general-purpose OS kernel, so various user-friendly functions may be performed. More specifically, the display device may be, for example, a network TV, HBBTV, smart TV, LED TV, OLED TV, etc., and in some cases, may also be applied to a smartphone.

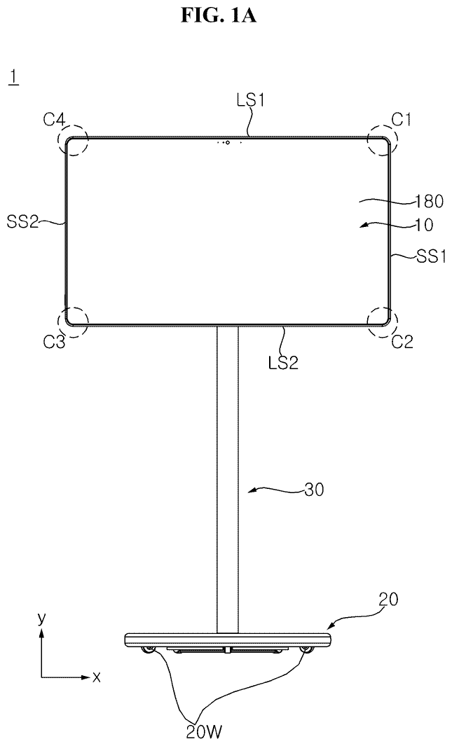

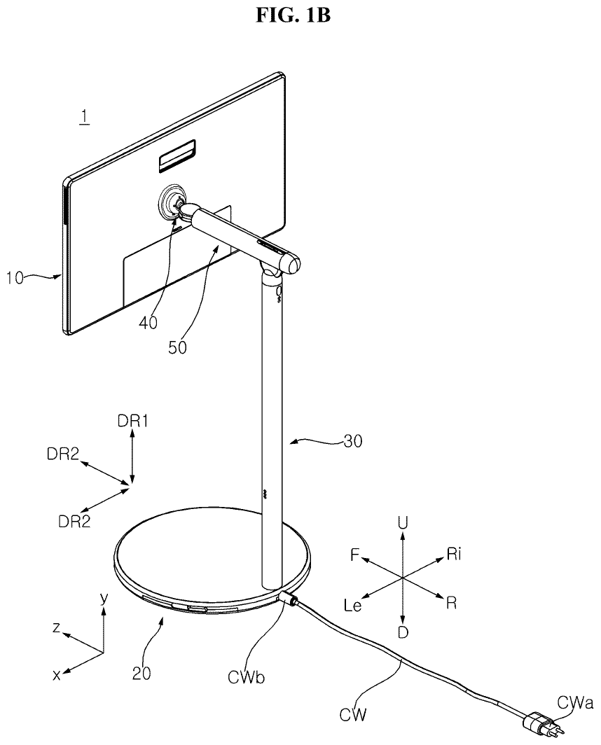

FIGS. 1A and 1B are diagrams illustrating the structure of a display device according to an embodiment of the present disclosure.

FIGS. 1A and 1B, the display device 1 may include a head 10. The head 10 may include a display panel that displays an image.

The head 10 may include a first long side (LS1), a second long side (LS2) opposing the first long side (LS1), a first short side (SS1) adjacent to the first long side (LS1), and the second long side (LS2) and a second short side (SS2) opposite to the first short side (SS1).

Meanwhile, for convenience of explanation, the length of the first and second long sides LS1 and LS2 is shown and described as being longer than the length of the first and second short sides SS1 and SS2. It may be possible that the length of the second long sides LS1 and LS2 is approximately the same as the length of the first and second short sides SS1 and SS2.

A direction parallel to the short sides (SS1, SS2) of the head 10 may be referred to as an up-down direction or a first direction DR1. The direction parallel to the long sides LS1 and LS2 of the head 10 may be referred to as a left and right direction or a second direction DR2. A direction perpendicular to the short sides (SS1, SS2) and long sides (LS1, LS2) of the head 10 may be referred to as a forward-backward direction or a third direction DR3.

The direction in which the head 10 displays an image may be referred to as a front (F, z), and the opposite direction may be referred to as a rear (R). The first short side (SS1) may be referred to as a left side (Le, x). The second short side (SS2) may be referred to as a right side (Ri). The first long side (LS1) may be referred to as a upper side (U, y). The second long side (LS2) may be referred to as a bottom side (D).

The first long side (LS1), the second long side (LS2), the first short side (SS1), and the second short side (SS2) may be referred to as edges of the head 10. The point where the first long side (LS1), the second long side (LS2), the first short side (SS1), and the second short side (SS2) meet each other may be called a corner. The point where the first short side (SS1) and the first long side (LS1) meet may be the first corner (C1). The point where the first short side (SS1) and the second long side (LS2) meet may be the second corner (C2).

The point where the second short side (SS2) and the second long side (LS2) meet may be the third corner (C3). The point where the second short side (SS2) and the first long side (LS1) meet may be the fourth corner (C4).

The display device 1 may include stand 20, 30, 40, and 50 that support the head 10.

The stand 20, 30, 40, and 50 may include a base 20, a pole 30, a rotatable connector 40, and a support arm 50.

The stand 20, 30, 40, and 50 may be detachably coupled to the head 10.

The base 20 may be placed on the ground. The base 20 may be round or angular. A plurality of wheels 20W may be provided on a lower surface of the base 20.

A plug (CWa) connected to a power cable (CW) may be connected to an concentric plug that supplies an external power.

A jack (CWb) of the power cable (CW) may be connected to the base 20.

A battery (not shown) may be built into the base 20, pole 30, support arm 50, and/or head 10, and may be charged by power supplied through the power cable (CW). The display device 1 may receive power from the battery and may be operated while disconnected from the power cable (CW).

The pole 30 may extend vertically from the base 20. A lower end of the pole 30 may be coupled to the pole 30 adjacent to a circumference of the base 20.

The support arm 50 may extend in a direction crossing the pole 30 and may be coupled to a top of the pole 30. The rotatable connector 40 may be located between the head 10 and the support arm 50 and may be coupled to the head 10 and the support arm 50.

The head 10 may be supported by stand 20, 30, 40, and 50 and may be spaced upward from the ground.

The rotatable connector 40 may rotate the head 10 up and down or left and right.

When an external force is applied to the rotatable connector 40, the head 10 may be rotated in one or more of the up/down/left/right directions.

The rotatable connector 40 and the head 10 may have a detachable structure.

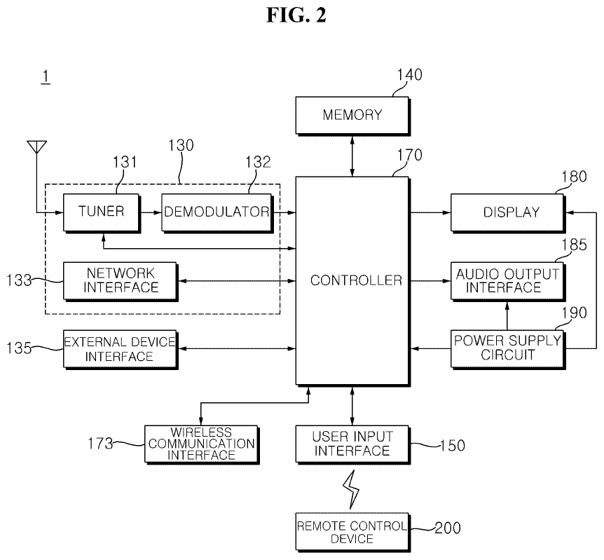

FIG. 2 is a block diagram showing a configuration of a display device according to an embodiment of the present disclosure.

Referring to FIG. 2, the display device 1 may include a broadcast receiver 130, an external device interface 135, a memory 140, a user input interface 150, a controller 170, a wireless communication interface 173, a display 180, a speaker 185, and a power supply circuit 190.

The broadcast receiver 130, the external device interface 135, the memory 140, the user input interface 150, the controller 170, the wireless communication interface 173, the display 180, the speaker 185, and the power supply circuit 190 may each be provided in the head 10. However, they are not limited to this arrangement, and some elements may also be provided in the stand 20, 30, 40, 50.

The broadcast receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the display device 1 and an external device. The external device interface 135 may receive one or more of images and audio output from an external device connected to the display device 1 in a wired or wireless manner, and transmit the same to the controller 170.

The external device interface 135 may include a plurality of external input terminals. The plurality of external input terminals may include an RGB terminal, one or more High Definition Multimedia Interface (HDMI) terminals, and a component terminal.

The image signal of the external device input through the external device interface unit 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

The external device interface 135 may be provided in one or more of the head 10 or the stand 20, 30, 40, 50.

The network interface 133 may provide an interface for connecting the display device 1 to a wired/wireless network including an Internet network.

The network interface 133 may transmit or receive data to or from other users or other electronic devices through a connected network or another network linked to the connected network.

In addition, a part of content data stored in the display device 1 may be transmitted to a selected user among a selected user or a selected electronic device among other users or other electronic devices registered in advance in the display device 1.

The network interface 133 may access a predetermined web page through the connected network or the other network linked to the connected network. That is, it is possible to access a predetermined web page through a network, and transmit or receive data to or from a corresponding server.

The network interface 133 may receive content or data provided by a content provider or a network operator. That is, the network interface 133 may receive content such as movies, advertisements, games, VOD, and broadcast signals and information related thereto provided from a content provider or a network provider through a network.

The network interface 133 may receive update information and update files of firmware provided by the network operator, and may transmit data to an Internet or content provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

The memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 1 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 1.

In addition, the controller 170 may control the display device 1 by a user command input through the user input interface 150 or an internal program and connect to a network to download an application a list of applications or applications desired by the user to the display device 1.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface unit or an image which is stored in the memory 140 to be displayed on the display 180. In this case, an image being displayed on the display 180 may be a still image or a moving image, and may be a 2D image or a 3D image.

In addition, the controller 170 may allow content stored in the display device 1, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi(Wireless-Fidelity), Wi-Fi Direct, and Wireless USB (Wireless Universal Serial Bus) technologies.

The wireless communication interface 173 may support wireless communication between the display device 1 and a wireless communication system, between the display device 1 and another display device 1, or between the display device 1 and a network in which the display device 1 (or an external server) is located through wireless area networks. The wireless area networks may be wireless personal area networks.

The wireless communication interface 173 may detect (or recognize) a wearable device capable of communication around the display device 1.

When the detected wearable device is an authenticated device to communicate with the display device 1 according to the present disclosure, the controller 170 may transmit at least a portion of data processed by the display device 1 to the wearable device through the wireless communication interface 173. Therefore, a user of the wearable device may use data processed by the display device 1 through the wearable device.

The display 180 may convert image signals, data signals, and OSD signals processed by the controller 170, or image signals or data signals received from the external device interface 135 into R, G, and B signals, and generate drive signals.

Meanwhile, since the display device 1 shown in FIG. 1 is only an embodiment of the present disclosure, some of the illustrated components may be integrated, added, or omitted depending on the specification of the display device 1 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 1 shown in FIG. 1, the display device 1 may receive an image through the network interface 133 or the external device interface 135 without a tuner 131 and a demodulator 132 and play back the same.

For example, the display device 1 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 1 as described with reference to FIG. 1 and but also one of an image processing device such as the separated set-top box and a content playback device including the display 180 the speaker 185.

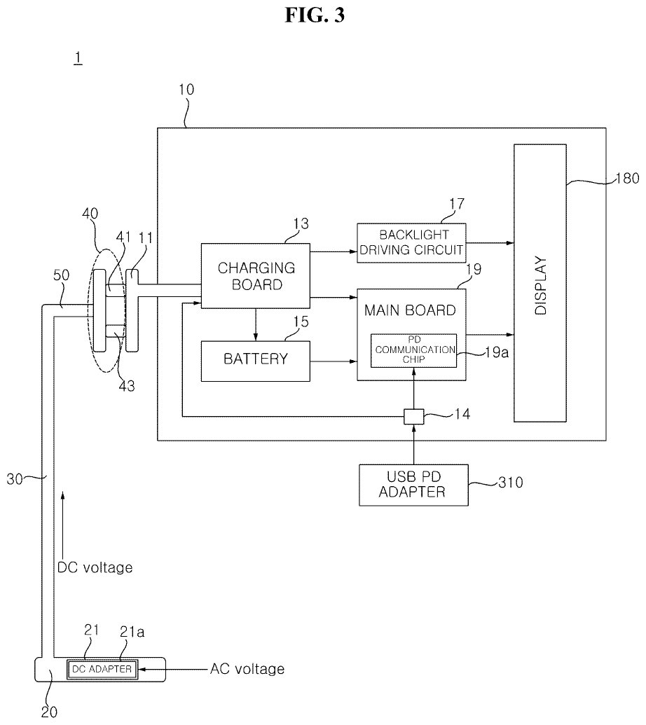

FIG. 3 is a diagram illustrating the configuration of a display device according to an embodiment of the present disclosure.

Referring to FIG. 3, the display device 1 may include a stand 20, 30, 40, and 50 and a head 10.

The stand 20, 30, 40, and 50 may include a base 20, a pole 30, a rotary connector 40, and a support arm 50.

The stand 20, 30, 40, and 50 may be detachably coupled to the head 10.

The base 20 may include a power board 21. That is, the power board 21 may be built into the base 20. The power board 21 may receive AC power from an external power source connected through a plug (CWa) and convert the received AC power into DC power. The power board 21 may supply DC power to the head 10 through one or more pogo pins 41 and 43 included in the connector 40.

The power board 21 may include a DC adapter 21a that may convert AC power to DC power. In another embodiment, the DC adapter 21a may be provided separately from the power board 21.

The power board 21 may detect whether the DC adapter 21a is connected and generate a detection signal based on a detection result. The power board 21 may transmit the generated detection signal to the main board 19.

The rotary connector 40 may include one or more pogo pins 41 and 43. One or more pogo pins 41 and 43 may be pins that electrically connect the head 10 and the stand 20, 30, 40, and 50.

In FIG. 3, the rotary connector 40 is described as having two pogo pins 41 and 43, but this is only an example.

One or more pogo pins 41 and 43 may be connected to a head connector 11 that includes one or more contact terminals that contact the one or more pogo pins 41 and 43. The head connector 11 may be a pogo pin socket into which pogo pins 41 and 43 are inserted to form electrical contact.

The head 10 may include a head connector 11, a charging board 13, a battery 15, a backlight driving circuit 17, a main board 19, and a display 180.

The head connector 11 may include one or more pogo pins 41 and 43 and one or more contact terminals for electrical contact. The head connector 11 may provide DC power supplied from one or more pogo pins 41 and 43 to the charging board 13 through one or more contact terminals. The head connector 11 may be an interface for electrical connection between one or more pogo pins 41 and 43 and the charging board 13.

The charging board 13 may provide DC power supplied from the power board 21 to the elements provided in the head 10.

The charging board 13 may provide DC power supplied from the power board 21 to one or more of the battery 15, the backlight driving circuit 17, or the main board 19.

The battery 15 may supply DC power to one or more of the backlight driving circuit 17 or the main board 19.

The battery 15 may be included in the charging board 13 or may be provided separately from the charging board 13.

The battery 15 may supply DC power to the head 10 through discharge when the DC adapter 21a and the USB PD adapter 310 are separated from the head 10.

The backlight driving circuit 17 may be a circuit for driving the backlight of the display 180. The display 180 may include a liquid crystal display panel and a backlight that outputs light to the liquid crystal display panel. The backlight driving circuit 17 may control the light output of the backlight based on a dimming value.

The main board 19 may control the overall operation of the head 10. The main board 19 may include one or more processors. Each of one or more processors may consist of one chip.

The display 180 may display an image. When the display 180 includes an Organic Light Emitting Diode (OLED) display panel, the backlight driving circuit 17 may not be included in the head 10.

The head 10 may further include a USB terminal 14 for connection to a USB device.

A USB PD adapter 310 may be connected to the USB terminal 14 through a USB cable. The USB PD adapter 310 may supply DC power to the head 10 through the USB terminal 14.

The USB PD adapter 310 may convert AC power into DC power and supply the converted DC power to the head 10.

The PD communication chip 19a provided on the main board 19 may detect whether the USB PD adapter 310 is connected.

The specific operation of the main board 19 will be described later.

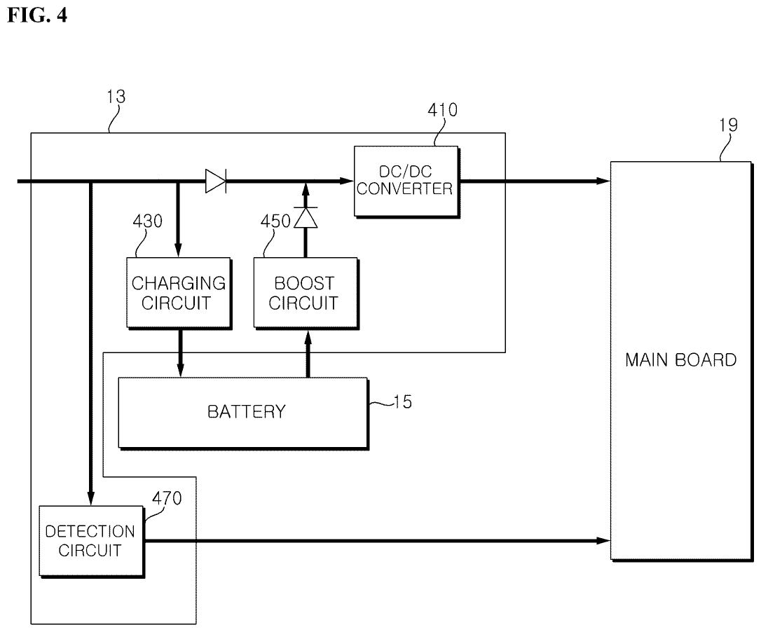

FIG. 4 is a diagram illustrating the configuration of a charging board according to an embodiment of the present disclosure.

The charging board 13 may include a DC/DC converter 410, a charging circuit 430, a boost circuit 450, and a detection circuit 470.

The DC/DC converter 410 may convert the DC power delivered from the power board 21 into a constant voltage and supply the converted constant voltage to the main board 19.

For example, the DC/DC converter 410 may step down a DC voltage of 20V to 13V and supply the step down DC voltage of 13V to the main board 19.

The charging circuit 430 may charge the battery 15 using DC power delivered from the power board 21. The charging circuit 430 may control charging or discharging of the battery 15. The charging circuit 430 may include a battery management system integrated chip (BMS IC) for controlling charging or discharging of the battery 15.

The charging circuit 430 may charge the battery 15 according to the charging on signal received from the main board 19 and stop charging the battery 15 according to the charging off signal.

The boost circuit 450 may change the output voltage of the battery 15 to a preset voltage and provide the changed voltage to the DC/DC converter 410. The boost circuit 450 may increase the output voltage of the battery 15 to the preset voltage and output the preset voltage.

For example, the boost circuit 450 may convert the output voltage of the battery 15 into a DC voltage of 17.5 V and output the DC voltage of 17.5 V.

The detection circuit 470 may include one or more Zener diodes and a low dropout (LDO) circuit.

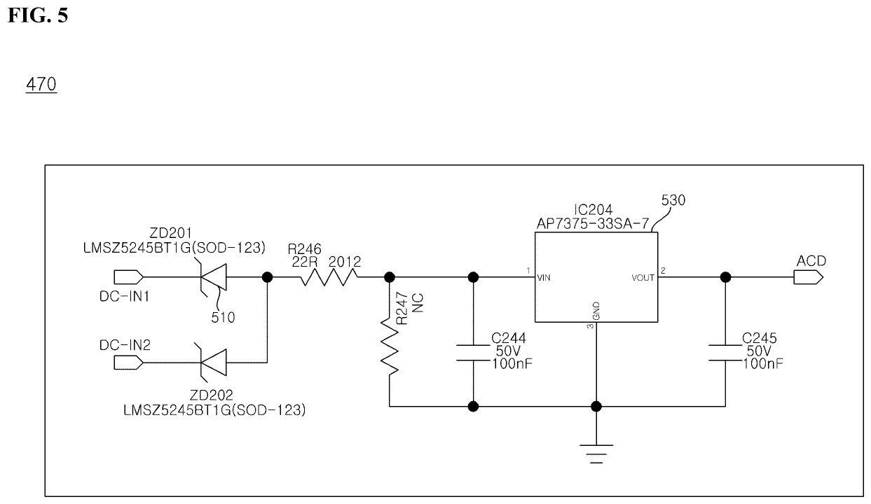

FIG. 5 is a diagram illustrating a circuit diagram of a detection circuit according to an embodiment of the present disclosure.

Referring to FIG. 5, the detection circuit 470 may include a Zener diode 510 and a LDO circuit 530. The detection circuit 470 may further include a plurality of resistors (R246, R247) and a capacitor (C244) connected between the Zener diode 510 and the LDO circuit 530.

The input voltage input to the charging board 13 through the pogo pins 41 and 43 may be applied to a cathode terminal of the Zener diode 510. One end of the resistor R246 may be connected to an anode terminal of the Zener diode 510.

The detection circuit 470 may further include a capacitor C245 connected between the LDO circuit 530 and the ACD pin (ACD).

The Zener diode 510 may be a diode designed to allow current to flow in the reverse direction at a specific voltage (or Zener voltage). The Zener voltage of the Zener diode 510 may be 15.5V.

When 20V output from the pogo pins 41 and 43 is input to the cathode terminal of the Zener diode 510, 4.5V, which is 20V minus 15.5V, which is the Zener voltage, may be applied to the LDO circuit 530.

The LDO circuit 530 may be a circuit that outputs a preset voltage when the input voltage is more than a certain voltage. The LDO circuit 530 may output 3.3V when the input voltage is 3.5V or more, and may reduce the output voltage depending on the input voltage when the input voltage is less than 3.5V. When the input voltage is less than 3.5V, the LDO circuit 530 may linearly reduce the output voltage according to the input voltage.

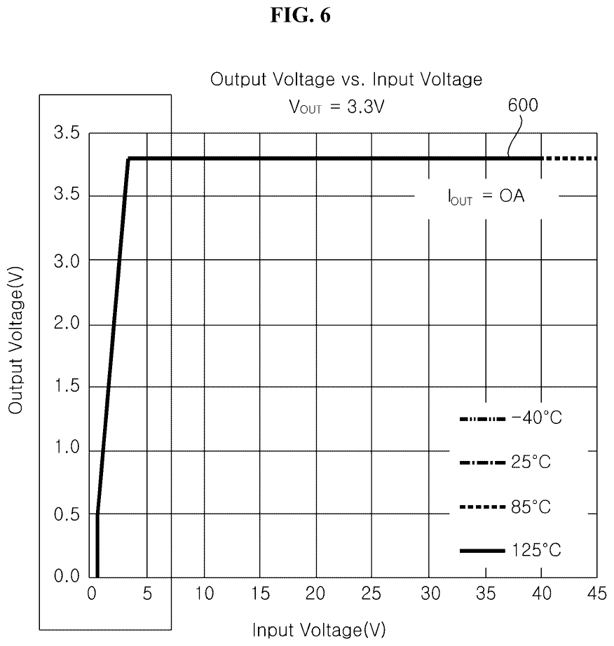

FIG. 6 is a diagram illustrating an operating principle of an LDO circuit according to an embodiment of the present disclosure.

Referring to FIG. 6, a graph 600 is shown showing the relationship between the input voltage and output voltage of the LDO circuit 530.

The horizontal axis of the graph 600 may represent the input voltage of the LDO circuit 530, and the vertical axis of the graph 600 may represent the output voltage output from the LDO circuit 530.

The LDO circuit 530 may output a constant voltage of 3.3V when the input voltage is 3.5V or more. When the input voltage is less than 3.5V, the LDO circuit 530 may output an output voltage proportional to the input voltage.

When the input voltage of the LDO circuit 530 is 3.5V to 4.5V, the output voltage of the LDO circuit 530 is always 3.3V, but when the input voltage is less than 3.5V, the output voltage may also be reduced in proportion to the input voltage, as shown in the graph 600.

When a DC voltage of 20V is applied to the detection circuit 470, a DC voltage of 4.5V may be applied to the LDO circuit 530 by the Zener diode 510 with the Zener voltage of 15.5V. Since the input voltage of the LDO circuit 530 is 3.5V or more, it may output 3.3V.

When a DC voltage of 18V is applied to the detection circuit 470, a DC voltage of 2.5V may be applied to the LDO circuit 530 by the Zener diode 510 with the Zener voltage of 15.5V. Since the input voltage of the LDO circuit 530 is less than 3.5V, the LDO circuit 530 may output 1.7V according to the graph 600.

The output voltage of the LDO circuit 530 may be the output voltage of the detection circuit 470.

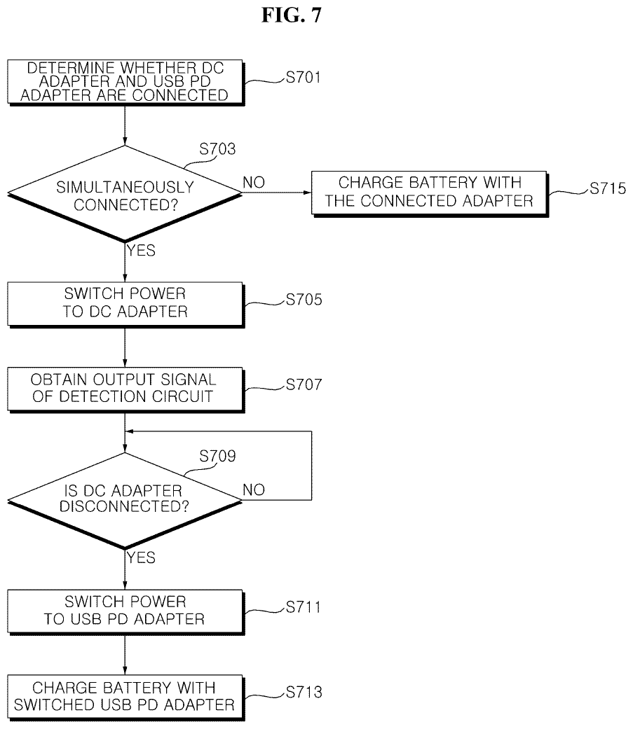

FIG. 7 is a flowchart illustrating a method of operating a display device according to an embodiment of the present disclosure.

Hereinafter, the display device 1 may be referred to as an electronic device 1.

The main board 19 may be referred to as a main processor 19.

That the DC adapter 21a is connected to the display device 1 or the head 10 may indicate that the display device 1 or the head 10 is receiving DC power from the DC adapter 21a.

That the USB PD adapter 310 is connected to the display device 1 or the head 10 may indicate that the display device 1 or the head 10 is receiving DC power from the USB PD adapter 310.

Referring to FIG. 7, the main board 19 of the display device 1 may determine whether each of the DC adapter 21a and the USB PD adapter 310 are connected (S701).

The main board 19 may determine whether the DC adapter 21a is connected based on the output signal output by the detection circuit 470 provided on the charging board 13. When the main board 19 receives a high signal from the detection circuit 470, the main board 19 may determine that the DC adapter 21a is connected to the head 10, and when the main board 19 receives a low signal, determine that the DC adapter 21a is not connected to the head 10.

The main board 19 may determine whether the USB PD adapter 310 is connected based on the detection signal detected by the PD communication chip 19a. The PD communication chip 19a may determine whether the USB PD adapter 310 is connected based on a resistance detected through the configuration channel (CC) pin of the USB terminal 14.

The PD communication chip 19a may determine that the USB PD adapter 310 is connected when the resistance detected through the configuration channel (CC) pin of the USB terminal 14 is a specific value or more than a specific value.

When it is determined that the DC adapter 21a and the USB PD adapter 310 are simultaneously connected to the display device 1 (S703), the main board 19 may switch the power to the DC adapter (S705).

When it is determined that the DC adapter 21a and the USB PD adapter 310 are connected to the display device 1 at the same time, the main board 19 may determine the adapter 21a as the power source to be supplied DC power to the head 10 through the DC adapter 21a.

This is because the DC adapter 21a has a larger power capacity and better power stability than the USB PD adapter 310.

The main board 19 may control an adapter switch 800, which will be described later, so that DC power provided from the DC adapter 21a is supplied to the battery 15. The adapter switch 800 may be a switch circuit that selectively connects either the DC adapter 21a or the USB adapter 21a to the charging circuit 430.

The main board 19 may obtain the output signal of the detection circuit 470 (S707).

The main board 19 may periodically obtain the output signal of the detection circuit 470 after the power is switched to the DC adapter 21a. The main board 19 may obtain the output signal of the detection circuit 470 to detect whether the DC adapter 21a is disconnected.

The detection circuit 470 may obtain the output voltage of the DC adapter 21a as the input voltage. The detection circuit 470 may output a high signal or a low signal based on the input voltage.

In one embodiment, when the output voltage of the detection circuit 470 is 3.3V or more, the detection circuit 470 may output a high signal, and when the output voltage of the detection circuit 470 is less than 3.3V, the detection circuit 470 may output a low signal.

In another embodiment, when the output voltage of the detection circuit 470 is 3.3V or more, the detection circuit 470 may output a high signal, and when the output voltage of the detection circuit 470 is less than 2.7V, the detection circuit 470 may output a low signal.

The main board 19 may determine whether the DC adapter 21a is disconnected based on the obtained output signal (S709).

If the obtained output signal is the high signal, the main board 19 may determine that the connection of the DC adapter 21a is maintained.

When the obtained output signal is the low signal, the main board 19 may determine that the DC adapter 21a is disconnected.

When it is determined that the DC adapter 21a is disconnected based on the obtained output signal, the main board 19 may switch the power to the USB PD adapter 310 (S711).

When it is determined that the DC adapter 21a is disconnected, the main board 19 may switch the power source from the DC adapter 21a to the USB PD adapter 310. When it is determined that the DC adapter 21a is disconnected, the main board 19 may control the adapter switch 800 to switch the power source to the USB PD adapter 310.

The adapter switch 800 may set the path of the DC power provided to the charging circuit 430 to the USB PD adapter 310 under the control of the main board 19.

The main board 19 may charge the battery 15 with the switched USB PD adapter 310 (S713).

As such, according to an embodiment of the present disclosure, the output voltage of the DC adapter 21a may be monitored, and whether or not to remove power from the DC adapter 21a may be quickly determined through the output signal according to the monitoring result.

Accordingly, the delay in detection time required to detect whether the DC adapter 21a is connected to the power source, due to discharge of the capacitor inside the DC adapter 21a or the capacitor in the path connected from the DC adapter 21a to the charging board 13, may be improved.

In addition, according to an embodiment of the present disclosure, as the detection time of the DC adapter 21a is improved, the power may be quickly switched to the USB PD adapter 310 to stably supply power to the battery 15 or the display 180.

Meanwhile, the main board 19 may charge the battery 15 with the connected adapter when only one of the DC adapter 21a and the USB PD adapter 310 is connected to the display device 1 (S715).

The main board 19 may control the charging circuit 430 to charge the battery 15 with the connected adapter when only one of the DC adapter 21a and the USB PD adapter 310 is connected to the display device 1.

The main board 19 may turn off the power of the boost circuit 450 when only one of the DC adapter 21a and the USB PD adapter 310 is connected to the display device 1. This will be described later.

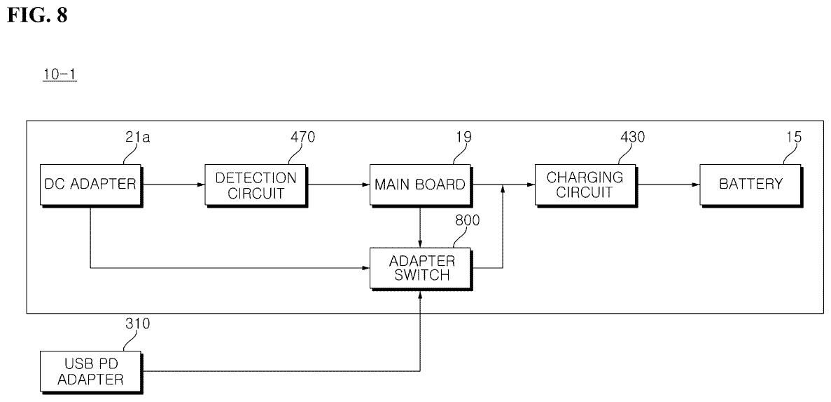

FIG. 8 is a block diagram showing the configuration of a head according to another embodiment of the present disclosure.

The head 10-1 of the display device 1 according to another embodiment of the present disclosure may include a DC adapter 21a, a detection circuit 470, a main board 19, an adapter switch 800, and a charging circuit 430 and a battery 15.

The DC adapter 21a may convert AC power into DC power, and transmit the converted DC power to the adapter switch 800 or the detection circuit 470.

The detection circuit 470 may include one or more Zener diodes and a low dropout (LDO) circuit. The circuit configuration of the detection circuit 470 is as described in FIG. 5.

The detection circuit 470 may output a high signal when the output voltage of the LDO circuit 530 is equal to or more than a certain voltage, and may output a low signal when the output voltage of the LDO circuit 530 is less than the certain voltage.

The main board 19 may control the overall operation of the head 10-1. The main board 19 may detect whether the DC adapter 21a is connected based on the output signal transmitted from the detection circuit 470.

If the obtained output signal is the high signal, the main board 19 may determine that the DC adapter 21a is connected.

When the obtained output signal is the low signal, the main board 19 may determine that the DC adapter 21a is disconnected.

The main board 19 may detect whether the USB PD adapter 310 is connected through the PD communication chip 19a.

The adapter switch 800 may supply DC power provided from any one of the DC adapter 21a and the USB PD adapter 310 to the charging circuit 430.

The adapter switch 800 may determine the power supply path of the adapter according to the control of the main board 19.

The charging circuit 430 may receive DC power from either the DC adapter 21a or the USB PD adapter 310. The charging circuit 430 may supply the received DC power to the battery 15.

The charging circuit 430 may control charging of the battery 15. The charging circuit 430 may charge or discharge the battery 15.

The boost circuit 450 may maintain the voltage output from the battery 15 at a constant voltage. The boost circuit 450 may increase the voltage output to the battery 15 to the constant voltage. Boost circuit 450 may include a converter.

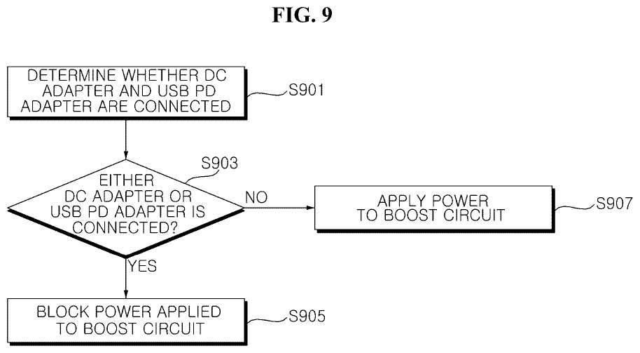

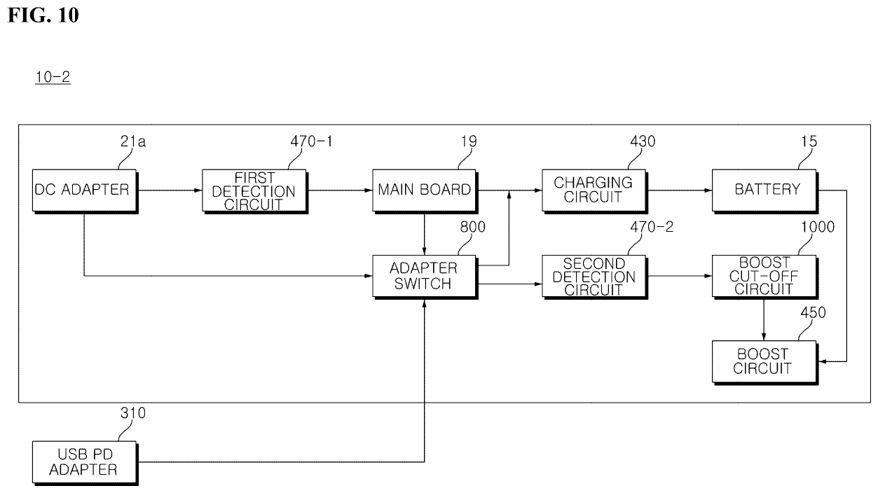

FIG. 9 is a flowchart for illustrating a method of operating a display device according to another embodiment of the present disclosure, and FIG. 10 is a diagram illustrating the configuration of the head 10-2 according to another embodiment of the present disclosure.

The head 10-2 according to another embodiment of the present disclosure may include a DC adapter 21a, a first detection circuit 470-1, a main board 19, an adapter switch 800, and a second detection circuit 470-2, a boost cut-off circuit 1000, a boost circuit 450, a charging circuit 430, and a battery 15.

The main board 19 of the display device 1 may determine whether the DC adapter 21a and the USB PD adapter 310 are connected (S901).

The main board 19 may determine whether the DC adapter 21a is connected based on the output signal output from the first detection circuit 470-1. The first detection circuit 470-1 may be the detection circuit 470 described in FIG. 5.

When the output signal of the first detection circuit 470-1 is a high signal, the main board 19 may determine that the DC adapter 21a is connected to the display device 1.

When the output signal of the first detection circuit 4702-is a low signal, the main board 19 may determine that the DC adapter 21a is disconnected.

The main board 19 may determine whether the USB PD adapter 310 is connected based on the detection signal detected by the PD communication chip provided therein.

When it is determined that either the DC adapter 21a or the USB PD adapter 310 is connected to the display device 1 (S903), the main board 19 may block the power applied to the boost circuit 450. (S905).

Conventionally, when either the DC adapter 21a or the USB PD adapter 310 is connected to the display device 1, power is applied to the boost circuit to perform a boost operation. The boost operation (or pre-boost operation) may be an operation that increases the voltage output from the battery 15 to a constant voltage for stable output of the battery 15.

The boost operation requires discharging of the battery 15, which may increase the recharge cycle of the battery 15. If the recharge cycle of the battery 15 increases, problems such as heat generation and reduced lifespan of the battery 15 occur.

In order to solve the above problem, the main board 19 according to an embodiment of the present disclosure may block the power applied to a boost circuit 450 when it is determined that either the DC adapter 21a or the USB PD adapter 310 is connected to the display device 1.

In order to block the power applied to the boost circuit 450, the head 10-2 or the main board 19 may include a second detection circuit 470-2 and a boost cut-off circuit 1000.

This will be described later.

When it is determined that both the DC adapter 21a and the USB PD adapter 310 are not connected to the display device 1 (S903), the main board 19 may apply power to the boost circuit 450 (S907).

Referring to FIG. 10, the head 10-2 according to another embodiment of the present disclosure may include a DC adapter 21a, a first detection circuit 470-1, a main board 19, an adapter switch 800, a second detection circuit 470-2, a boost cut-off circuit 1000, a boost circuit 450, a charging circuit 430, and a battery 15.

Hereinafter, the second detection circuit 470-2 and the boost cut-off circuit 1000 are described as separate elements from the main board 19, but are not limited thereto.

The main board 19 may include one or more of a second detection circuit 470-2 or a boost blocking circuit 1000.

The DC adapter 21a may convert AC power into DC power, and transmit the converted DC power to the adapter switch 800 or the first detection circuit 470-1.

The first detection circuit 470-1 may include one or more Zener diodes and a low dropout (LDO) circuit. The circuit configuration of the first detection circuit 470-2 is as described in FIG. 5.

The main board 19 may control the overall operation of the head 10-2. The main board 19 may detect whether the DC adapter 21a is connected based on the output signal transmitted from the first detection circuit 470-1.

If the obtained output signal is a high signal, the main board 19 may determine that the connection of the DC adapter 21a is maintained.

When the obtained output signal is a low signal, the main board 19 may determine that the DC adapter 21a is disconnected.

The main board 19 may detect whether the USB PD adapter 310 is connected through the PD communication chip 19a.

The adapter switch 800 may supply DC power provided from any one of the DC adapter 21a and the USB PD adapter 310 to the charging circuit 430.

The adapter switch 800 may determine the power supply path of the adapter according to the control of the main board 19.

The second detection circuit 470-2 may output a high signal or a low signal based on the voltage output from the adapter switch 800. The second detection circuit 470-2 may be disposed between the output terminal of the adapter switch 800 and the input terminal of the boost blocking circuit 1000.

The second detection circuit 470-2 may have the same configuration as the detection circuit 470 shown in FIG. 5. The second detection circuit 470-2 may output a high signal if the output voltage according to the input voltage is 3.3V or more, and may output a low signal if the output voltage according to the input voltage is less than 3.3V.

The high signal may be a signal indicating that one of the DC adapter 21a and the USB PD adapter 310 is connected to the head 10-2.

The low signal may be a signal indicating that the DC adapter 21a and the USB PD adapter 310 are not connected to the head 10-2.

The boost blocking circuit 1000 may block power applied to the boost circuit 450 based on the signal output from the second detection signal 470-2.

When the signal output from the second detection signal 470-2 is a high signal, the boost blocking circuit 1000 may block power applied to the boost circuit 450 through an internal switching operation.

When the signal output from the second detection signal 470-2 is a low signal, the boost cutoff circuit 1000 may apply power to the boost circuit 450 through an internal switching operation.

The boost circuit 450 may maintain the voltage output from the battery 15 at a constant voltage according to the applied power.

The charging circuit 430 may receive DC power from either the DC adapter 21a or the USB PD adapter 310. The charging circuit 430 may supply the received DC power to the battery 15.

The charging circuit 430 may control charging of the battery 15. The charging circuit 430 may charge or discharge the battery 15.

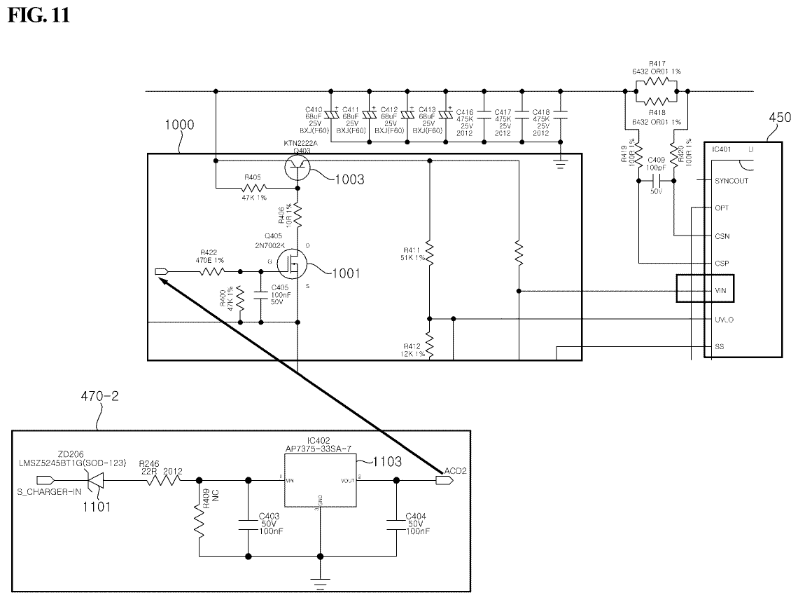

FIG. 11 is a diagram illustrating a circuit diagram of a second detection circuit and a boost blocking circuit according to an embodiment of the present disclosure.

Referring to FIG. 11, circuit diagrams of each of the second detection circuit 470-2 and the boost blocking circuit 1000 are shown.

The second detection circuit 470-2 may include a Zener diode 1101 and an LDO circuit 1103. The functions of the Zener diode 1101 and the LDO circuit 1103 are replaced with the description of the Zener diode 510 and the LDO circuit 530 in FIG. 5.

The boost blocking circuit 1000 may include a first switching element 1001 and a second switching element 1003. The first switching element 1001 may be a Field Effect Transistor (FET), and the second switching element 1003 may be a Bipolar Junction Transistor (BJT).

When the second detection circuit 470-2 outputs a high signal, the first switching element 1001 is turned on and the second switching element 1003 is turned off, and the power (VIN) applied to the boost circuit 450 may be blocked. When the power applied to the boost circuit 450 is cut off, the pre-boost operation of the battery 15 may be bypassed (operating in a pre-boost bypass mode).

When the second detection circuit 470-2 outputs an off signal, the first switching element 1001 is turned off, the second switching element 1003 is turned on, and the power VIN may be applied to the boost circuit 450.

As such, according to an embodiment of the present disclosure, when either the DC adapter 21a or the USB PD adapter 310 is connected to the display device 1, the power applied to the boost circuit 450 through the boost blocking circuit 1000 may be cut off.

Accordingly, the power required for the boost operation is no longer needed, and the battery 15 may not be discharged. As the battery 15 is not discharged, the recharge cycle of the battery 15 is reduced, thereby solving the problem of heat generation and reduced lifespan of the battery 15.

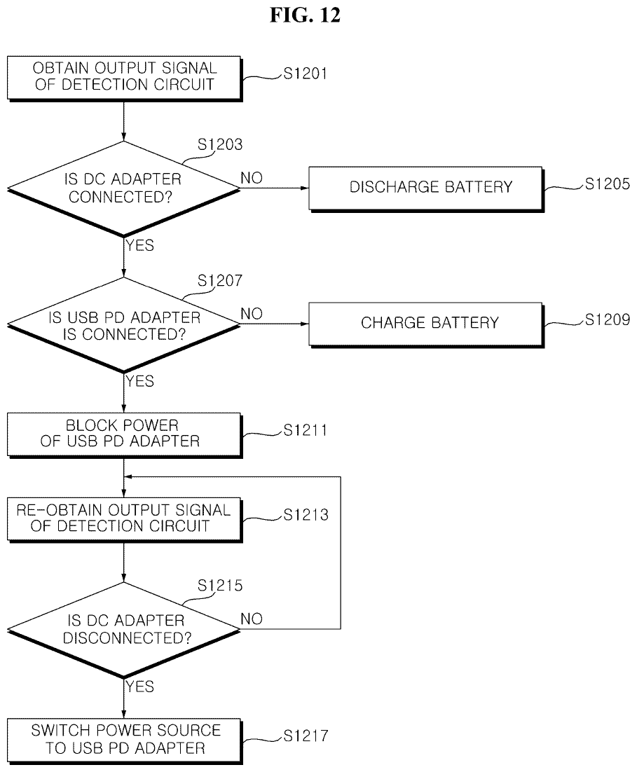

FIG. 12 is a flowchart for illustrating a method of operating a display device according to another embodiment of the present disclosure.

In particular, FIG. 12 may be a more specific embodiment of the embodiment of FIG. 7. In FIG. 12, the description is made using the configuration of the head 10-1 of FIG. 8.

Referring to FIG. 12, the main board 19 of the display device 1 may obtain the output signal of the detection circuit 470 (S1201).

The main board 19 may determine whether the DC adapter 21a is connected to the display device 1 based on the output signal of the detection circuit 470 (S1203).

When the output signal of the detection circuit 470 is a high signal, the main board 19 may determine that the DC adapter 21a is connected.

If the output signal of the detection circuit 470 is a low signal, the main board 19 may determine that the DC adapter 21a is not connected.

When it is determined that the DC adapter 21a is not connected to the display device 1 based on the output signal of the detection circuit 470 (S1203), the main board 19 may discharge the battery 15 (S1205).

The main board 19 may control the charging circuit 430 so that the battery 15 is discharged. The charging circuit 430 may transmit a discharge signal to the battery 15 to discharge the battery 15. The discharged power of the battery 15 may be used to drive the display 180.

When it is determined that the DC adapter 21a is connected to the display device 1, the main board 19 may determine whether the USB PD adapter 310 is connected to the display device 1 (S1207).

The main board 19 may determine whether the USB PD adapter 310 is connected to the display device 1 through the PD communication chip 19a. The PD communication chip 19a may determine whether the USB PD adapter 310 is connected based on the resistance detected through the configuration channel (CC) pin of the USB terminal 14.

The main board 19 may charge the battery 15 using the power provided through the DC adapter 21a when the DC adapter 21a is connected to the display device 1 and the USB PD adapter 310 is not connected to the display device 1 (S1209).

The main board 19 may display a graphic user interface (GUI) indicating the charging state of the battery on the display 180.

When the DC adapter 21a and the USB PD adapter 310 are connected, the main board 19 may block power transmitted from the USB PD adapter 310 (S1211).

The main board 19 may turn off (or deactivate) VBUS, which is the power supply line of the USB terminal 14. Accordingly, the power supplied from the USB PD adapter 310 may be cut off.

The main board 19 may re-obtain the output signal of the detection circuit 470 (S1213) and determine whether the DC adapter 21a is disconnected based on the re-obtained output signal (S1215).

If the re-obtained output signal is a low signal, the main board 19 may switch the power source from the DC adapter 21a to the USB PD adapter 310 (S1217).

The main board 19 may control the adapter switch 800 to switch the power source from the DC adapter 21a to the USB PD adapter 310 when the DC adapter 21a is disconnected.

The main board 19 may turn on (or activate) VBUS when the DC adapter 21a is disconnected. Accordingly, power supplied through the USB PD adapter 310 may be provided to the battery 15.

The main board 19 may display a graphic user interface (GUI) indicating a charging state of the battery on the display 180.

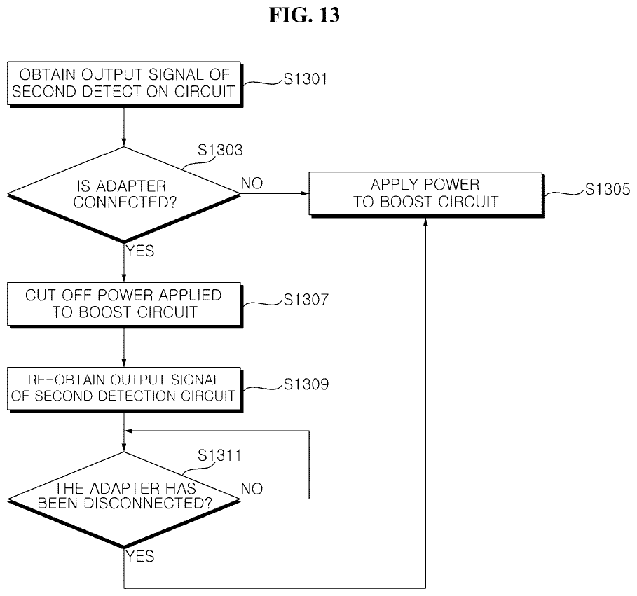

FIG. 13 is a flowchart for illustrating a method of operating a display device according to another embodiment of the present disclosure.

In particular, FIG. 13 may be a more specific embodiment of the embodiment of FIG. 9. In FIG. 13, the configuration of the head 10-2 of FIG. 9 is used for explanation.

The main board 19 of the display device 1 may obtain the output signal of the second detection circuit 470-2 (S1301).

The main board 19 may determine whether the adapter is connected based on the obtained output signal (S1303).

The main board 19 may determine whether the DC adapter 21a or the USB PD adapter 310 is connected based on the obtained output signal.

If it is determined that the adapter is not connected, the main board 19 may apply power to the boost circuit 450 (S1305).

The main board 19 may apply power to the boost circuit 450 when it is determined that the DC adapter 21a and the USB PD adapter 310 are not connected.

When the output signal of the second detection circuit 470-2 is a low signal, the boost blocking circuit 1000 of the main board 19 may turn off the first switching element 1001 and turn on the second switching element 1003 to block the power applied to the boost circuit 450.

If it is determined that the adapter is connected, the main board 19 may cut off the power applied to the boost circuit 450 (S1307).

When the output signal of the second detection circuit 470-2 is a high signal, the boost blocking circuit 1000 of the main board 19 may turn on the first switching element 1001 and turn off the second switching element 1003 to block the power applied to the boost circuit 450.

The main board 19 may control the charging circuit 430 to supply power to the battery 15 through a connected adapter. The main board 19 may update a graphic user interface (GUI) indicating the charging state of the battery 15 and display the updated GUI on the display 180.

The main board 19 may re-obtain the output signal of the second detection circuit 470-2 (S1309).

The main board 19 may determine whether the adapter has been disconnected based on the re-obtained output signal (S1311).

If the re-obtained output signal is a low signal, the main board 19 may determine that the adapter has been disconnected.

When it is determined that the adapter is disconnected, the main board 19 may apply power to the boost circuit 450.

When it is determined that the adapter is disconnected, the main board 19 may control the charging circuit 430 to discharge the battery 15. The main board 19 may update a graphic user interface (GUI) indicating the charging state of the battery 15 and display the updated GUI on the display 180.

As such, according to an embodiment of the present disclosure, when either the DC adapter 21a or the USB PD adapter 310 is connected to the display 1, the power applied to the boost circuit 450 may be blocked. Accordingly, the battery 15 is not discharged, and the recharge cycle of the battery may be reduced.

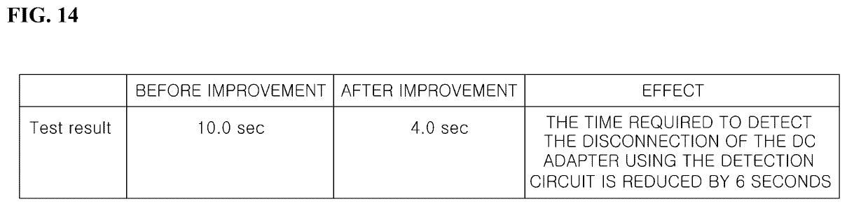

FIG. 14 is a diagram illustrating an effect that occurs when disconnection of a DC adapter is detected using a detection circuit according to an embodiment of the present disclosure.

The conventional main board receives a detection signal indicating disconnection of the DC adapter through the power board. In this case, even if the DC adapter was disconnected, it took 10 seconds to detect the disconnection of the DC adapter due to natural discharge of the capacitor inside the DC adapter or the capacitor in the path between the DC adapter and the charging board.

It took 4 seconds for the main board 19 according to an embodiment of the present disclosure to detect disconnection of the DC adapter 21a by measuring the output voltage relative to the voltage of the discharged capacitor using the detection circuit 470.

In other words, by using the detection circuit 470, the time required to determine that the DC adapter is disconnected has become 6 seconds faster than before. Accordingly, when the DC adapter 21a and the USB PD adapter 310 are simultaneously connected and the DC adapter 21a is disconnected, the power source may be quickly switched to the USB PD adapter 310.

That is, as the power source is quickly switched to the USB PD adapter 310, power may be smoothly supplied to the elements of the display device 1.

An electronic device 1 according to an embodiment of the present disclosure may comprise a first detection circuit (470, 470-1) configured to output a signal indicating whether a first adapter 21a is connected; and a main board 19 configured to: detect a disconnection of the first adapter based on the signal output from the first detection circuit while the first adapter and a second adapter 310 are connected simultaneously, and switch a power source of the electronic device from the first adapter to the second adapter according to detecting the disconnection of the first adapter.

The first detection circuit (470, 470-1) may comprise a Zener diode 510 having a Zener voltage, and

a Low DropOut (LDO) circuit 530 configured to output a preset voltage when a first voltage more than a certain voltage is input, and output a voltage proportional to a second voltage when the second voltage less than the certain voltage is input.

The first detection circuit (470, 470-1) may output a high signal indicating that the first adapter is connected when a voltage more than the preset voltage is output, and output a low signal indicating that the first adapter is disconnected when a voltage less than the preset voltage is output.

The electronic device may further comprise a battery 15, wherein the main board 19 may further charge the battery through the second adapter when the first adapter is disconnected.

The electronic device may further comprise a second detection circuit 470-2 configured to detect whether either the first adapter or the second adapter is connected and a boost blocking circuit 1000 configured to apply or block power to a boost circuit 450 that converts a discharge voltage of the battery to a constant voltage based on the output signal of the second detection circuit.

The boost blocking circuit 1000 may cut off the power applied to the boost circuit when the second detection circuit outputs a high signal indicating that either the first adapter or the second adapter is connected, and apply the power to the boost circuit when the second detection circuit outputs a low signal indicating that the first adapter and the second adapter are not connected.

The second detection 470-2 circuit may comprise a Zener diode having a Zener voltage, and

A Low DropOut (LDO) circuit configured to output a preset voltage when a first voltage higher than a certain voltage is input, and output a voltage proportional to a second voltage when the second voltage less than the specific voltage is input.

The second detection circuit 470-2 may output a high signal indicating that the first adapter or the second adapter is connected when the preset voltage is output, and output a low signal indicating that the first adapter and the second adapter are not connected when a voltage less than the preset voltage is output.

The boost blocking circuit may comprise a first switching element 1001 and a second switching element 1003, when the high signal is output, the first switching element is turned on and the second switching element is turned off, and when the low signal is output, the first switching element is turned off and the second switching element is turned on.

The electronic device may further comprise an adapter switch 800 configured to output a power provided from any one of the first adapter and the second adapter.

The second detection circuit 470-2 may be disposed between the adapter switch and the boost blocking circuit.

The electronic device may further comprise a battery 15, wherein the main board 19 may supply a power provided from the first adapter to the battery when the first adapter and the second adapter are connected.

The first adapter is a DC adapter 21a, and the second adapter is a USB (Universal Serial Bus) PD (Power Delivery) adapter 310.

An electronic device 1 may comprise a stand 20, 30, 40, 50 configured to receive an external power from a first adapter; and

A head 10, 10-1, 10-2 supported by the stand and including a display 180 and a battery 15, wherein the head being electrically coupled to the stand through a pogo pin, a first detection circuit and a main board are provided in the head, wherein the first detection circuit 470, 470-1 is configured to output a signal indicating whether a first adapter is connected; and wherein the main board is configured to: detect a disconnection of the first adapter based on the signal output from the first detection circuit while the first adapter and a second adapter are connected simultaneously, and switch a power source of the electronic device from the first adapter to the second adapter according to detecting the disconnection of the first adapter.

According to an embodiment of the present disclosure, the above-described method may be implemented as processor-readable code on a program-recorded medium. Examples of media that the processor may read include ROM, RAM, CD-ROM, magnetic tape, floppy disk, and optical data storage device.

The display device described above is not limited to the configuration and method of the above-described embodiments, and the embodiments may be configured by selectively combining all or part of each embodiment so that various modifications may be made.

What is claimed is:

1. An electronic device, comprising:
a first detection circuit configured to output a signal indicating whether a first adapter is connected; and
a main board configured to:
detect a disconnection of the first adapter based on the signal output from the first detection circuit while the first adapter and a second adapter are connected simultaneously, and
switch a power source of the electronic device from the first adapter to the second adapter according to detecting the disconnection of the first adapter.

2. The electronic device of claim 1, wherein the first detection circuit comprises:
a Zener diode having a Zener voltage, and
a Low DropOut (LDO) circuit configured to output a preset voltage when a first voltage more than a certain voltage is input, and output a voltage proportional to a second voltage when the second voltage less than the certain voltage is input.

3. The electronic device of claim 2, wherein the first detection circuit is configured to:
output a high signal indicating that the first adapter is connected when a voltage more than the preset voltage is output, and
output a low signal indicating that the first adapter is disconnected when a voltage less than the preset voltage is output.

4. The electronic device of claim 1, further comprising a battery,
wherein the main board is further configured to charge the battery through the second adapter when the first adapter is disconnected.

5. The electronic device of claim 1, further comprising:
a second detection circuit configured to detect whether either the first adapter or the second adapter is connected; and
a boost blocking circuit configured to apply or block power to a boost circuit that converts a discharge voltage of the battery to a constant voltage based on the output signal of the second detection circuit.

6. The electronic device of claim 5, wherein the boost blocking circuit is configured to:
cut off the power applied to the boost circuit when the second detection circuit outputs a high signal indicating that either the first adapter or the second adapter is connected, and
apply the power to the boost circuit when the second detection circuit outputs a low signal indicating that the first adapter and the second adapter are not connected.

7. The electronic device of claim 6, wherein the second detection circuit comprises:
a Zener diode having a Zener voltage, and
a Low DropOut (LDO) circuit configured to output a preset voltage when a first voltage higher than a certain voltage is input, and output a voltage proportional to a second voltage when the second voltage less than the specific voltage is input.

8. The electronic device of claim 7, wherein the second detection circuit is configured to:
output a high signal indicating that the first adapter or the second adapter is connected when the preset voltage is output, and
output a low signal indicating that the first adapter and the second adapter are not connected when a voltage less than the preset voltage is output.

9. The electronic device of claim 8, wherein the boost blocking circuit comprises a first switching element and a second switching element,
when the high signal is output, the first switching element is turned on and the second switching element is turned off, and
when the low signal is output, the first switching element is turned off and the second switching element is turned on.

10. The electronic device of claim 5, further comprising an adapter switch configured to output a power provided from any one of the first adapter and the second adapter.

11. The electronic device of claim 10, wherein the second detection circuit is disposed between the adapter switch and the boost blocking circuit.

12. The electronic device of claim 1, further comprising a battery,
wherein the main board is configured to supply a power provided from the first adapter to the battery when the first adapter and the second adapter are connected.

13. The electronic device of claim 1, wherein the first adapter is a DC adapter, and the second adapter is a USB (Universal Serial Bus) PD (Power Delivery) adapter.

14. An electronic device, comprising:
a stand configured to receive an external power from a first adapter; and
a head supported by the stand and including a display and a battery, wherein the head being electrically coupled to the stand through a pogo pin,
a first detection circuit and a main board are provided in the head,
wherein the first detection circuit is configured to output a signal indicating whether a first adapter is connected; and
wherein the main board is configured to:
detect a disconnection of the first adapter based on the signal output from the first detection circuit while the first adapter and a second adapter are connected simultaneously, and
switch a power source of the electronic device from the first adapter to the second adapter according to detecting the disconnection of the first adapter.

15. A method of operating an electronic device, comprising:
outputting a signal indicating whether a first adapter is connected;
detecting a disconnection of the first adapter based on the signal output from a first detection circuit while the first adapter and a second adapter are connected simultaneously, and
switching a power source of the electronic device from the first adapter to the second adapter according to detecting the disconnection of the first adapter.
